(19) United States
(12) Patent Application Publication
(10) Pub. No.: US 2013/0209814 A1
(43) Pub. Date: Aug. 15, 2013

(54) REFLECTIVE ARTICLES AND METHODS OF MAKING THE SAME

(71) Applicants: Vivek Bharti, Cottage Grove, MN (US); Rajesh K. Katare, Cottage Grove, MN (US); Susannah C. Clear, Hastings, MN (US); Suresh S. Iyer, Woodbury, MN (US)

(72) Inventors: Vivek Bharti, Cottage Grove, MN (US); Rajesh K. Katare, Cottage Grove, MN (US); Susannah C. Clear, Hastings, MN (US); Suresh S. Iyer, Woodbury, MN (US)

(73) Assignee: 3M INNOVATIVE PROPERTIES COMPANY, ST. PAUL, MN (US)

(21) Appl. No.: 13/817,237

(22) PCT Filed: Oct. 28, 2011
(86) PCT No.: PCT/US11/58209

§ 371 Date: Feb. 15, 2013

Related U.S. Application Data
(60) Provisional application No. 61/409,210, filed on Nov. 2, 2010.

(51) Int. Cl. G02B 5/08

(52) U.S. Cl. CPC G02B 5/0808
USPC 428/463; 427/162; 428/469; 428/472

(57) ABSTRACT

Reflective articles and related methods of manufacture are provided. These articles include a metallic layer extending across a non-tacky base layer. The base layer includes either a block copolymer or random copolymer with at least two polymeric components, one of which has a glass transition temperature of at least 50 degrees Celsius and the other of which has a glass transition temperature no greater than 20 degrees Celsius. These articles provide excellent optical clarity, non-corrosiveness, ultraviolet light stability, and resistance to outdoor weathering conditions compared to conventional reflective films.

### 1. FIELD OF THE INVENTION

Provided are reflective articles and related methods of manufacture. More particularly, the provided reflective articles and methods of manufacture may be used in cosmetic, packaging and solar reflector applications.

### 2. DESCRIPTION OF THE RELATED ART

Renewable energy is energy derived from natural resources that can be replenished, such as sunlight, wind, rain, tides, and geothermal heat. The demand for renewable energy has grown substantially with advances in technology and increases in global population. Although fossil fuels provide for the vast majority of energy consumption today, these fuels are non-renewable. The global dependence on these fossil fuels has not only raised concerns about their depletion but also environmental concerns associated with emissions that result from burning these fuels. As a result of these concerns, countries worldwide have been establishing initiatives to develop both large-scale and small-scale renewable energy resources. One of the promising energy resources today is sunlight. Globally, millions of households currently obtain power from solar photovoltaic systems.

Concentrated solar power plants collect solar radiation in order to directly or indirectly provide the hot side of an engine that is used to produce electricity. These systems use mirrored surfaces in multiple geometries, dictated by the design of the system. These geometries include flat mirrors, parabolic dishes and parabolic troughs, among others. These reflective surfaces concentrate sunlight onto a receiver. That, in turn, heats a working fluid (e.g. a synthetic oil or a molten salt). In some cases, the working fluid is what drives the engine that produces electricity, and in other cases, this working fluid is passed through a heat exchanger to produce steam, which is used to power a steam turbine to generate electricity.

Solar thermal systems collect solar radiation to heat water or to heat process streams in industrial processes. Some solar thermal designs make use of reflective mirrors to concentrate sunlight onto receivers that contain water or the feed stream. The principle of operation is very similar to concentrated solar power plants, but the concentration of sunlight and therefore the working temperatures are not as high.

The rising demand for solar thermal systems has been accompanied by rising demands for reflective devices and materials capable of fulfilling the requirements for these applications. Some of these solar reflector technologies include glass mirrors, aluminized mirrors, and metalized polymer films. Of these, metalized polymer films are particularly attractive because they are lightweight and offer design flexibility and potentially enable cheaper installed system designs than conventional glass mirrors.

Other important commercial applications for these reflective devices and materials include photovoltaic concentrators, natural lighting in building, digital signs, automotive applications such as headlight reflectors, and residential light reflectors. Metalized films can also be used for cosmetic applications, or for food packaging to prevent gases and light rays from degrading food products. Reflective film sheeting can also be used by museums and archival institutions to protect collectibles from damaging light rays.

### SUMMARY OF THE INVENTION

A technical challenge in designing and manufacturing metalized polymer reflective films is achieving long-term durability when subjected to harsh environmental conditions. Mechanical properties, optical clarity, corrosion, ultraviolet light stability, and resistance to outdoor weather conditions are all factors that can contribute to the gradual degradation of materials over an extended period of operation. One particular difficulty relates to ensuring good adhesion between certain transparent, environmentally durable polymer exteriors and the metal reflective surface.

Provided is a solution in which the issue is overcome by using a layer containing a copolymer that combines a polymeric unit with a relatively low glass transition temperature with one that has a relatively high glass transition temperature. These copolymers may be used either as a self-supporting base layer or as an organic tie layer located between a separate polymeric top layer and a metallic layer. Advantageously, these copolymers were found to significantly enhance the adhesion of the reflective coating on polymers with high weatherability, such as poly(methyl methacrylate). Additionally, these materials can also display a sufficient degree of weatherability, optical clarity, and ultraviolet light stability. These copolymers were also found to diffuse mechanical stresses present at interfaces that lead to loss of adhesion at or near the interface.

In one aspect, a reflective article is provided. The reflective article comprises: a base layer having a first and second surface, the base layer being non-tacky at ambient temperatures and comprising a block copolymer with at least two endblock polymeric units that are each derived from a first monoethylenically unsaturated monomer comprising a methacrylate, acrylate, styrene, or combination thereof, wherein each endblock has a glass transition temperature of at least 50 degrees Celsius; and at least one midblock polymeric unit that is derived from a second monoethylenically unsaturated monomer comprising a methacrylate, acrylate, vinyl ester, or combination thereof, wherein each midblock has a glass transition temperature no greater than 20 degrees Celsius; and a metallic layer extending across at least a portion of the second surface.

In another aspect, a reflective article is provided, comprising: a base layer having a first and second surface, the base layer comprising a random copolymer with at least a first polymeric unit and second polymeric unit, the first polymeric unit derived from a first monoethylenically unsaturated monomer comprising a methacrylate, acrylate, styrene, or combination thereof and associated with a glass transition temperature of at least 50 degrees Celsius and the second polymeric unit derived from a second monoethylenically unsaturated monomer comprising a methacrylate, acrylate, vinyl ester, or combination thereof and associated with a glass transition temperature no greater than 20 degrees Celsius; a top layer extending across at least a portion of the first surface comprising poly(methyl methacrylate); and a metallic layer extending across at least a portion of the second surface.

In still another aspect, a method of making a reflective article is provided, comprising: providing a base layer having a first and second surface, the base layer being non-tacky at ambient temperatures and comprising a block copolymer with at least two endblock polymeric units that are each derived from a first monoethylenically unsaturated monomer comprising a methacrylate, acrylate, styrene, or combination thereof, wherein each endblock has a glass transition temperature of at least 50 degrees Celsius; and at least one midblock polymeric unit that is derived from a second monoethylenically unsaturated monomer comprising a methacrylate, acrylate, vinyl ester, or combination thereof, wherein each midblock has a glass transition temperature no greater than 20 degrees Celsius; and applying a metallic layer along the second surface to provide a reflective surface.

### BRIEF DESCRIPTION OF THE DRAWINGS

FIG. 1 is a cross-sectional view showing layers of a reflective article according to one embodiment.

FIG. 2 is a cross-sectional view showing layers of a reflective article according to another embodiment.

FIG. 3 is a cross-sectional view showing layers of a reflective article according to still another embodiment.

### DETAILED DESCRIPTION OF THE PREFERRED EMBODIMENTS

Provided herein are reflective articles and related methods of manufacturing the same. These reflective articles include at least one layer including a block copolymer or random copolymer in contact with one or more layers of metal. While these articles are generally intended for use in reflective applications, this should not be deemed to unduly limit the invention. For example, these articles are also contemplated for non-reflective uses such as in food storage or vapor barrier applications.

The terms “a”, “an”, and “the” are used interchangeably with “at least one” to mean one or more of the elements being described.

A stated range includes endpoints and all numbers between the endpoints. For example, the range of 1 to 10 includes 1, 10, and all numbers between 1 and 10.

The term “ambient temperatures” refers to a temperature in the range of 20 degrees Celsius to 25 degrees Celsius.

### Block Copolymers

In some embodiments, the provided reflective articles have a non-tacky base layer that includes one or more block copolymers.

As used herein, the term “block copolymer” refers to a polymeric material that includes a plurality of distinct polymeric segments (or “blocks”) that are covalently bonded to each other. A block copolymer includes (at least) two different polymeric blocks, commonly referred to as the A block and the B block. The A block and the B block generally have chemically dissimilar compositions with different glass transition temperatures.

Further, each of the A and B blocks includes a plurality of respective polymeric units. The A block polymeric units, as well as the B block polymeric units, are generally derived from monoethylenically unsaturated monomers. Each polymeric block and the resulting block copolymer have a saturated polymeric backbone without the need for subsequent hydrogenation.

An “ABA” triblock copolymer has a pair of A endblocks covalently coupled to a B midblock. As used herein, the term “endblock” refers to the terminal segments of the block copolymer and the term “midblock” refers to the central segment of the block copolymer. The terms “A block” and “A endblock” are used interchangeably herein. Likewise, the terms “B block” and “B midblock” are used interchangeably herein.

The block copolymer with at least two A block and a least one B block can also be a star block copolymer having at least three segments of formula (A-B)-. Star block copolymers often have a central region from which various branches extend. In these cases, the B blocks are typically in the central regions and the A blocks are in the terminal regions of the star block copolymers.

In preferred embodiments, the A blocks are more rigid than the B block. That is, the A blocks have a higher glass transition temperature and have a higher hardness than that of the B block. As used herein, the term “glass transition temperature,” or “T_{g},” refers to the temperature at which a polymeric material undergoes a transition from a glassy state to a rubbery state. The glassy state is typically associated with a material that is, for example, brittle, stiff, rigid, or a combination thereof. In contrast, the rubbery state is typically associated with a material that is flexible and/or elastomeric. The B block is commonly referred to as a soft block while the A blocks are referred to as hard blocks.

The glass transition temperature can be determined using a method such as Differential Scanning calorimetry (DSC) or Dynamic Mechanical Analysis (DMA). Preferably, the A blocks have a glass transition temperature of at least 50 degrees Celsius and the B block has a glass transition temperature no greater than 20 degrees Celsius. In exemplary block copolymers, the A blocks have a T_{g} of at least 60 degrees Celsius, at least 80 degrees Celsius, at least 100 degrees Celsius, or at least 120 degrees Celsius while the B block has a glass transition temperature no greater than 10 degrees Celsius, no greater than 0 degrees Celsius, no greater than −5 degrees Celsius, or no greater than −10 degrees Celsius.

In some embodiments, the A block component is a thermoplastic material while the B block component is an elastomeric material. As used herein, the term “thermoplastic” refers to a polymeric material that flows when heated and that returns to its original state when cooled back to room temperature. As used herein, the term “elastomeric” refers to a polymeric material that can be stretched to at least twice its original length and then retracted to approximately its original length upon release.

The solubility parameter of the A blocks is preferably substantially different from the solubility parameter of the B block. Stated differently, the A blocks are typically not compatible or miscible with the B block, and this generally results in localized phase separation, or “microphase separation”, of the A and B blocks. Microphase separation can advantageously impart elastomeric properties and dimensional stability to a block copolymer material.

In some embodiments, the block copolymer has a multiphase morphology, at least at temperatures in the range of about 20 degrees Celsius to 150 degrees Celsius. The block copolymer can have distinct regions of reinforcing A block domains (e.g., nanodomains) in a matrix of the softer, elastomeric B block. For example, the block copolymer can have a discrete, discontinuous A block phase in a substantially continuous B block phase. In some such examples, the concentration of A block polymeric units is no greater than about 35 weight percent of the block copolymer. The A blocks usually provide the structural and cohesive strength for the block copolymer.

The monoethylenically unsaturated monomers that are suitable for the A block polymeric units preferably have a T_{g} of at least 50 degrees Celsius when reacted to form a homopolymer. In many examples, suitable monomers for the A block polymeric units have a T_{g} of at least 60 degrees Celsius, at least 80 degrees Celsius, at least 100 degrees Celsius, or at least 120 degrees Celsius when reacted to form a homopolymer. The T_{g} of these homopolymers can be up to 200 degrees Celsius or up to 150 degrees Celsius. The T_{g} of these homopolymers can be, for example, in the range of 50 degrees Celsius to 200 degrees Celsius, 50 degrees Celsius to 150 degrees Celsius, 60 degrees Celsius to 150 degrees Celsius, 80 degrees Celsius to 150 degrees Celsius, or 100 degrees Celsius to 150 degrees Celsius. In addition to these monomers having a T_{g} of at least 50 degrees Celsius when reacted to form a homopolymer, other monomers can be optionally included in the A block while the T_{g} of the A block remains at least 50 degrees Celsius.

The A block polymeric units may be derived from methacrylate monomers, styrenic monomers, or a mixture thereof. That is, the A block polymeric units may be the reaction product of a monoethylenically unsaturated monomer that is selected from a methacrylate monomer, styrenic monomer, or mixture thereof.

As used herein to describe the monomers used to form the A block polymeric units, the term “mixture thereof” means that more than one type of monomer (e.g., a methacrylate and styrene) or more than one of the same type of monomer (e.g., two different methacrylates) can be mixed. The at least two A blocks in the block copolymer can be the same or different. In many block copolymers all of the A block polymeric units are derived from the same monomer or monomer mixture.

In some embodiments, methacrylate monomers are reacted to form the A blocks. That is, the A blocks are derived from methacrylate monomers. Various combinations of methacrylate monomers may be used to provide an A block having a T_{g} of at least 50 degrees Celsius. The methacrylate monomers can be, for example, alkyl methacrylates, aryl methacrylates, or aralkyl methacrylate of Formula (I).

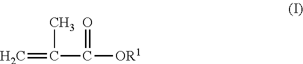

In Formula (I), R(1) is an alkyl, aryl, or aralkyl (i.e., an alkyl substituted with an aryl group).

Suitable alkyl groups often have 1 to 6 carbon atoms, 1 to 4 carbon atoms, or 1 to 3 carbon atoms. When the alkyl group has more than 2 carbon atoms, the alkyl group can be branched or cyclic. Suitable aryl groups often have 6 to 12 carbon atoms. Suitable aralkyl groups often have 7 to 18 carbon atoms.

Exemplary alkyl methacrylates according to Formula (I) include, but are not limited to, methyl methacrylate, ethyl methacrylate, isopropyl methacrylate, isobutyl methacrylate, tert-butyl methacrylate, and cyclohexyl methacrylate. In addition to the monomers of Formula (I), isobornyl methacrylate can be used. Exemplary aryl (meth)acrylates according to Formula (I) include, but are not limited to, phenyl methacrylate. Exemplary aralkyl methacrylates according to Formula (I) include, but are not limited to, benzyl methacrylate and 2-phenoxyethyl methacrylate.

In other embodiments, the A block polymeric units are derived from styrenic monomers. Exemplary styrenic monomers that can be reacted to form the A blocks include, but are not limited to, styrene, alpha-methylstyrene, and various alkyl substituted styrenes such as 2-methylstyrene, 4-methylstyrene, ethylstyrene, tert-butylstyrene, isopropylstyrene, and dimethylstyrene.

In addition to the monomers described above for the A blocks, these polymeric units can be prepared using up to 5 weight percent of the polar monomer such as methacrylamide, N-alkyl methacrylamide, N,N-dialkyl methacrylamide, or hydroxyalkyl methacrylate. These polar monomers can be used, for example, to adjust the cohesive strength of the A block and the glass transition temperature. Preferably, the T_{g} of each A block remains at least 50 degrees Celsius even with the addition of the polar monomer. Polar groups resulting from the polar monomers in the A block can function as reactive sites for chemical or ionic crosslinking, if desired.

The A block polymeric units can be prepared using up to 4 weight percent, up to 3 weight percent, or up to 2 weight percent of the polar monomer. In many examples, however, the A block polymeric units are substantially free or free of a polar monomer.

As used herein, the term “substantially free” in reference to the polar monomer means that any polar monomer that is present is an impurity in one of the selected monomers used to form the A block polymeric units.

The amount of polar monomer is less than 1 weight percent, less than 0.5 weight percent, less than 0.2 weight percent, or less than 0.1 weight percent of the monomers in the reaction mixture used to form the A block polymeric units.

The A block polymeric units are often homopolymers. In exemplary A blocks, the polymeric units are derived from an alkyl methacrylate monomers with the alkyl group having 1 to 6, 1 to 4, 1 to 3, 1 to 2, or 1 carbon atom. In some more specific examples, the A block polymeric units are derived from methyl methacrylate (i.e., the A blocks are poly(methyl methacrylate)).

The monoethylenically unsaturated monomers that are suitable for use in the B block polymeric unit usually have a T_{g} no greater than 20 degrees Celsius when reacted to form a homopolymer. In many examples, suitable monomers for the B block polymeric unit have a T_{g} no greater than 10 degrees Celsius, no greater than 0 degrees Celsius, no greater than −5 degrees Celsius, or no greater than −10 degrees Celsius when reacted to form a homopolymer.

The T_{g} of these homopolymers is often at least −80 degrees Celsius, at least −70 degrees Celsius, at least −60 degrees Celsius, or at least −50 degrees Celsius. The T_{g} of these homopolymers can be, for example, in the range of −80 degrees Celsius to 20 degrees Celsius, −70 degrees Celsius to 10 degrees Celsius, −60 degrees Celsius to 0 degrees Celsius, or −60 degrees Celsius to −10 degrees Celsius. In addition to these monomers having a T_{g} no greater than 20 degrees Celsius when reacted to form a homopolymer, other monomers can be included in the B block while keeping the T_{g} of the B block no greater than 20 degrees Celsius.

The B midblock polymeric unit is typically derived from (meth)acrylate monomers, vinyl ester monomers, or a combination thereof. That is, the B midblock polymeric unit is the reaction product of a second monomer selected from (meth)acrylate monomers, vinyl ester monomers, or mixtures thereof. As used herein, the term “(meth)acrylate” refers to both methacrylate and acrylate. More than one type of monomer (e.g., a (meth)acrylate and a vinyl ester) or more than one of the same type of monomer (e.g., two different (meth)acrylates) can be combined to form the B midblock polymeric unit.

In many embodiments, acrylate monomers are reacted to form the B block.

The acrylate monomers can be, for example, an alkyl acrylate or a heteroalkyl acrylate.
The B blocks are often derived from acrylate monomers of Formula (II).

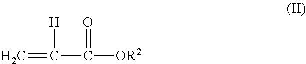

In Formula (II), R² is an alkyl with 1 to 22 carbons or a heteroalkyl with 2 to 20 carbons and 1 to 6 heteroatoms selected from oxygen or sulfur.

The alkyl or heteroalkyl group can be linear, branched, cyclic, or a combination thereof. Exemplary alkyl acrylates of Formula (II) that can be used to form the B block polymeric unit include, but are not limited to, ethyl acrylate, n-propyl acrylate, n-butyl acrylate, isobutyl acrylate, t-butyl acrylate, n-pentyl acrylate, isoamyl acrylate, n-hexyl acrylate, 2-methylbutyl acrylate, 2-ethylhexyl acrylate, 4-methyl-2-pentyl acrylate, n-octyl acrylate, isooctyl acrylate, isononyl acrylate, decyl acrylate, isodecyl acrylate, lauryl acrylate, isotridecyl acrylate, octadecyl acrylate, and dodecyl acrylate. Exemplary heteroalkyl acrylates of Formula (II) that can be used to form the B block polymeric unit include, but are not limited to, 2-methoxyethyl acrylate and 2-ethoxy ethyl acrylate.

Some alkyl methacrylates can be used to prepare the B blocks such as alkyl methacrylates having an alkyl group with greater than 6 to 20 carbon atoms. Exemplary alkyl methacrylates include, but are not limited to, 2-ethylhexyl methacrylate, isooctyl methacrylate, n-octyl methacrylate, isodecyl methacrylate, and lauryl methacrylate. Likewise, some heteroalkyl methacrylates such as 2-ethoxy ethyl methacrylate can also be used.

Polymeric units suitable for the B block can be prepared from monomers according to Formula (II). (Meth)acrylate monomers that are commercially unavailable or that cannot be polymerized directly can be provided through an esterification or trans-esterification reaction. For example, a (meth)acrylate that is commercially available can be hydrolyzed and then esterified with an alcohol to provide the (meth)acrylate of interest. Alternatively, a higher alkyl (meth)acrylate can be derived from a lower alkyl (meth)acrylate by direct trans-esterification of the lower alkyl (meth)acrylate with a higher alkyl alcohol.

In still other embodiments, the B block polymeric unit is derived from vinyl ester monomers. Exemplary vinyl esters include, but are not limited to, vinyl acetate, vinyl 2-ethyl-hexanoate, and vinyl neodecanoate.

In addition to the monomers described above for the B block, this polymeric unit can be prepared using up to 5 weight percent of the polar monomer such as acrylamide, N-alkyl acrylamide (e.g., N-methyl acrylamide), N,N-dialkyl acrylamide (N,N-dimethyl acrylamide), or hydroxyalkyl acrylate. These polar monomers can be used, for example, to adjust the glass transition temperature, while keeping the T_{g} of the B block less than 20 degrees Celsius. Additionally, these polar monomers can result in polar groups within the polymeric units that can function as reactive sites for chemical or ionic crosslinking, if desired.

The polymeric units can be prepared using up to 4 weight percent, up to 3 weight percent, up to 2 weight percent of the polar monomer. In other embodiments, the B block polymeric unit is free or substantially free of a polar monomer. As used herein, the term “substantially free” in reference to the polar monomer means that any polar monomer that is present is an impurity in one of the selected monomers used to form the B block polymeric unit.

Preferably, the amount of polar monomer is less than 1 weight percent, less than 0.5 weight percent, less than 0.2 weight percent, or less than 0.1 weight percent of the monomers used to form the B block polymeric units.

The B block polymeric unit may be a homopolymer. In some examples of the B block, the polymeric unit can be derived from an alkyl acrylate having an alkyl group with 1 to 22, 2 to 20, 3 to 20, 4 to 20, 4 to 18, 4 to 10, or 4 to 6 carbon atoms. Acrylate monomers such as alkyl acrylate monomers form homopolymers that are generally less rigid than those derived from their alkyl methacrylate counterparts.

Preferably, the composition and respective T_{g} of the A and B blocks provides for a non-tacky base layer. A base layer that is non-tacky is advantageous because it is easy to handle and manipulate. This, in turn, facilitates use of the base layer as a stand alone layer in manufacturing. Moreover, a non-tacky base layer also facilitates handling of the reflective film by the end user whenever the base layer is an exterior layer of the reflective film.

In some base layer compositions, the block copolymer is an ABA triblock (meth)acrylate block copolymer with an A block polymeric unit derived from a methacrylate monomer and a B block polymeric unit derived from an acrylate monomer. For example, the A block polymeric units can be derived from an alkyl methacrylate monomer and the B block polymer unit can be derived from an alkyl acrylate monomer.

In some more specific examples, the A blocks are derived from an alkyl methacrylate with an alkyl group having 1 to 6, 1 to 4, 1 to 3, or 1 to 2 carbon atoms and the B block is derived from an alkyl acrylate with an alkyl group having 3 to 20, 4 to 20, 4 to 18, 4 to 10, 4 to 6, or 4 carbon atoms. For example, the A blocks can be derived from methyl methacrylate and the B block can be derived from an alkyl acrylate with an alkyl group having 4 to 10, 4 to 6, or 4 carbon atoms.

In a more specific example, the A blocks can be derived from methyl methacrylate and the B block can be derived from n-butyl acrylate. That is, the A blocks are poly(methyl methacrylate) and the B block is poly(n-butyl acrylate).

Optionally, the weight percent of the B block equals or exceeds the weight percent of the A blocks in the block copolymer. Assuming that the A block is a hard block and the B block is a soft block, higher amounts of the A block tend to increase the modulus of the block copolymer. If the amount of the A block is too high, however, the morphology of the block copolymer may be inverted from the desirable arrangement where the B block forms a continuous phase and the block copolymer is an elastomeric material. That is, if the amount of the A block is too high, the copolymer tends to have properties more similar to a thermoplastic material than to an elastomeric material.

Preferably, the block copolymer contains 10 to 50 weight percent of the A block polymeric units and 50 to 90 weight percent of the B block polymeric units. For example, the block copolymer can contain 10 to 40 weight percent of the A block polymeric units and 60 to 90 weight percent of the B block polymeric units, 10 to 35 weight percent of the A block polymeric units and 65 to 90 weight percent of the B block polymeric units, 15 to 50 weight percent of the A block polymeric units and 50 to 85 weight percent of the B block polymeric units, 15 to 35 weight percent of the A block polymeric units and 65 to 85 weight percent of the B block polymeric units, 10 to 30 weight percent of the A block polymeric units and 70 to 90 weight percent of the B block polymeric units, 15 to 30 weight percent of the A block polymeric units and 70 to 85 weight percent of the B block polymeric units, 15 to 25 weight percent of the A block polymeric units and 75 to 85 weight percent of the B block polymeric units, or 10 to 20 weight percent of the A block polymeric units and 80 to 90 weight percent of the B block polymeric units.

The block copolymers can have any suitable molecular weight. In some embodiments, the molecular weight of the block copolymer is at least 2,000 g/mole, at least 3,000 g/mole, at least 5,000 g/mole, at least 10,000 g/mole, at least 15,000 g/mole, at least 20,000 g/mole, at least 25,000 g/mole, at least 30,000 g/mole, at least 40,000 g/mole, or at least 50,000 g/mole. In some embodiments, the molecular weight of the block copolymer is no greater than 500,000 g/mole, no greater than 400,000 g/mole, no greater than 200,000 g/mole, no greater than 100,000 g/mole, no greater than 50,000 g/mole, or no greater than 30,000 g/mole.

For example, the molecular weight of the block copolymer can be in the range of 1,000 to 500,000 g/mole, in the range of 3,000 to 500,000 g/mole, in the range of 5,000 to 100,000 g/mole, in the range of 5,000 to 50,000 g/mole, or in the range of 5,000 to 30,000 g/mole.

The molecular weight is typically expressed as the weight average molecular weight. Any known technique can be used to prepare the block copolymers. In some methods of preparing the block copolymers, iniferters are used as described in European Patent No. EP 349 232 (Andrus et al.). However, for some applications, methods of preparing block copolymers that do not involve the use of iniferters may be preferred because iniferters tend to leave residues that can be problematic especially in photo-induced polymerization reactions.

For example, the presence of thiocarbamate, which is a commonly used iniferter, may cause the resulting block copolymer to be more susceptible to weather-induced degradation. The weather-induced degradation may result from the relatively weak carbon-sulfur link in the thiocarbamate residue. The presence of thiocarbamate can often be detected, for example, using elemental analysis or mass spectroscopy. Thus, in some applications, it is desirable that the block copolymer is prepared using other techniques that do not result in the formation of this weak carbon-sulfur link.

Some suitable methods of making the block copolymers are living polymerization methods. As used herein, the term “living polymerization” refers to polymerization techniques, process, or reactions in which propagating species do not undergo either termination or transfer. If additional monomer is added after 100 percent conversion, further polymerization can occur.

The molecular weight of the living polymer increases linearly as a function of conversion because the number of propagating species does not change. Living polymerization methods include, for example, living free radical polymerization techniques and living anionic polymerization techniques. Specific examples of living free radical polymerization reactions include atom transfer polymerization reactions and reversible addition-fragmentation chain transfer polymerization reactions.

Block copolymers prepared using living polymerization methods tend to have well-controlled blocks. As used herein, the term “well-controlled” in reference to the method of making the blocks and the block copolymers means that the block polymeric units have at least one of the following characteristics: controlled molecular weight, low polydispersity, well-defined blocks, or blocks having high purity. Some blocks and block copolymers have a well-controlled molecular weight that is close to the theoretical molecular weight.

The theoretical molecular weight refers to the calculated molecular weight based on the molar charge of monomers and initiators used to form each block. Well-controlled blocks and block copolymers often have a weight average molecular weight (M_{w}) that is about 0.8 to 1.2 times the theoretical molecular weight or about 0.9 to 1.1 times the theoretical molecular weight. As such, the molecular weight of the blocks and of the total block can be selected and prepared.

Some blocks and block copolymers have low polydispersity. As used herein, the term “polydispersity” is a measure of the molecular weight distribution and refers to the weight average molecular weight (M_{w}) divided by the number average molecular weight (Mₙ) of the polymer. Materials with the same molecular weight have a polydispersity of 1.0 while materials with multiple molecular weights have a polydispersity greater than 1.0. The polydispersity can be determined, for example, using gel permeation chromatography.

Well-controlled blocks and block copolymers often have a polydispersity of 2.0 or less, 1.5 or less, or 1.2 or less.

Some block copolymers have well-defined blocks. That is, the boundaries between the A blocks and the continuous phase containing the B blocks are well defined.

These well-defined blocks have boundaries that are essentially free of tapered structures.
As used herein, the term “tapered structure” refers to a structure derived from monomers used for both the A and B blocks.

Tapered structures can increase mixing of the A block phase and the B block phase leading to decreased overall cohesive strength of the block copolymer or base layer containing the block copolymer. Block copolymers made using methods such as living anionic polymerization tend to result in boundaries that are free or essentially free of tapered structures.

The distinct boundaries between the A blocks and the B block often results in the formation of physical crosslinks that can increase overall cohesive strength without the need for chemical crosslinks. In contrast to these well-defined blocks, some block copolymers prepared using iniferters have less distinct blocks with tapered structures.

Optionally, the A blocks and B blocks have high purity. For example, the A blocks can be essentially free or free of segments derived from monomers used for the preparation of the B blocks. Similarly, B blocks can be essentially free or free of segments derived from monomers used for the preparation of the A blocks.

Living polymerization techniques typically lead to more stereoregular block structures than blocks prepared using non-living or pseudo-living polymerization techniques (e.g., polymerization reactions that use iniferters). Stereoregularity, as evidenced by highly syndiotactic structures or isotactic structures, tends to result in well-controlled block structures and tends to influence the glass transition temperature of the block.

For example, syndiotactic poly(methyl methacrylate) (PMMA) synthesized using living polymerization techniques can have a glass transition temperature that is about 20 degrees Celsius to about 25 degrees Celsius higher than a comparable PMMA synthesized using conventional (i.e., non-living) polymerization techniques. Stereoregularity can be detected, for example, using nuclear magnetic resonance spectroscopy. Structures with greater than about 75 percent stereoregularity can often be obtained using living polymerization techniques.

When living polymerization techniques are used to form a block, the monomers are generally contacted with an initiator in the presence of an inert diluent (or solvent). The inert diluent can facilitate heat transfer and mixing of the initiator with the monomers. Although any suitable inert diluent can be used, saturated hydrocarbons, aromatic hydrocarbons, ethers, esters, ketones, or a combination thereof are often selected.

Exemplary diluents include, but are not limited to, saturated aliphatic and cycloaliphatic hydrocarbons such as hexane, octane, cyclohexane, and the like; aromatic hydrocarbons such as toluene; and aliphatic and cyclic ethers such as dimethyl ether, diethyl ether, tetrahydrofuran, and the like; esters such as ethyl acetate and butyl acetate; and ketones such as acetone, methyl ethyl ketone, and the like.

When the block copolymers are prepared using living anionic polymerization techniques, the simplified structure A-M represents the living A block where M is an initiator fragment selected from a Group I metal such as lithium, sodium, or potassium.

For example, the A block can be the polymerization reaction product of a first monomer composition that includes methacrylate monomers according to Formula (I). A second monomer composition that includes the monomers used to form the B block can be added to A-M resulting in the formation of the living diblock structure A-B-M. For example, the second monomer composition can include monomers according to Formula (II). The addition of another charge of the first monomer composition, which can include monomers according to Formula (I), and the subsequent elimination of the living anion site can result in the formation of triblock structure A-B-A. Alternatively, living diblock A-B-M structures can be coupled using difunctional or multifunctional coupling agents to form the triblock structure A-B-A copolymers or (A-B)[n]-star block copolymers.
Any initiator known in the art for living anionic polymerization reactions can be used.
Typical initiators include alkali metal hydrocarbons such as organo lithium compounds (e.g., ethyl lithium, n-propyl lithium, iso-propyl lithium, n-butyl lithium, sec-butyl lithium, tert-octyl lithium, n-decyl lithium, phenyl lithium, 2-naphthyl lithium, A-butylphenyl lithium, 4-phenylbutyl lithium, cyclohexyl lithium, and the like). Such initiators can be useful in the preparation of living A blocks or living B blocks.

For living anionic polymerization of (meth)acrylates, the reactivity of the anion can be tempered by the addition of complexing ligands selected from materials such as crown ethers, or lithium ethoxylates. Suitable difunctional initiators for living anionic polymerization reactions include, but are not limited to, 1,1,4,4-tetraphenyl-1,4-dilithiobutane; 1,1,4,4-tetraphenyl-1,4-dilithioisobutane; and naphthalene lithium, naphthalene sodium, naphthalene potassium, and homologues thereof.

Other suitable difunctional initiators include dilithium compounds such as those prepared by an addition reaction of an alkyl lithium with a divinyl compound. For example, an alkyl lithium can be reacted with 1,3-bis(1-phenylethenyl)benzene or m-diisopropenylbenzene.

For living anionic polymerization reactions, it is usually advisable to add the initiator in small quantities (e.g., a drop at a time) to the monomers until the persistence of the characteristic color associated with the anion of the initiator is observed. Then, the calculated amount of the initiator can be added to produce a polymer of the desired molecular weight. The preliminary addition of small quantities often destroys contaminants that react with the initiator and allows better control of the polymerization reaction.

The polymerization temperature used depends on the monomers being polymerized and on the type of polymerization technique used. Generally, the reaction can be carried out at a temperature of about −100 degrees Celsius to about 150 degrees Celsius. For living anionic polymerization reactions, the temperature is often about −80 degrees Celsius to about 20 degrees Celsius. For living free radical polymerization reactions, the temperature is often about 20 degrees Celsius to about 150 degrees Celsius. Living free radical polymerization reactions tend to be less sensitive to temperature variations than living anionic polymerization reactions.

Methods of preparing block copolymers using living anionic polymerization methods are further described, for example, in U.S. Pat. Nos. 6,734,256 (Everaerts et al), 7,084,209 (Everaerts et al), 6,806,320 (Everaerts et al), and 7,255,920 (Everaerts et al.), incorporated herein by reference in their entirety. This polymerization method is further described, for example, in U.S. Pat. Nos. 6,630,554 (Hamada et al.) and 6,984,114 (Kato et al.) as well as in Japanese Patent Application Kokai Publication Nos. Hei 11-302617 (Uchiumi et al.) and 11-323072 (Uchiumi et al.)

In general, the polymerization reaction is carried out under controlled conditions so as to exclude substances that can destroy the initiator or living anion. Typically, the polymerization reaction is carried out in an inert atmosphere such as nitrogen, argon, helium, or combinations thereof. When the reaction is a living anionic polymerization, anhydrous conditions may be necessary.

Suitable block copolymers can be purchased from Kuraray Co., LTD. (Tokyo, Japan) under the trade designation LA POLYMER. Some of these block copolymers are triblock copolymers with poly(methyl methacrylate) endblocks and a poly(n-butyl acrylate) midblock. In some embodiments, more than one block copolymer is included in the base layer composition. For example, multiple block copolymers with different weight average molecular weights or multiple block copolymers with different block compositions can be used.

The use of multiple block copolymers with different weight average molecular weights or with different amounts of the A block polymeric units can, for example, improve the shear strength of the base layer composition.

If multiple block copolymers with different weight average molecular weights are included in the base layer composition, the weight average molecular weights can vary by any suitable amount. In some instances, the molecular weights of a first block copolymer can vary by at least 25 percent, at least 50 percent, at least 75 percent, at least 100 percent, at least 150 percent, or at least 200 percent from a second block copolymer having a larger weight average molecular weight.

The block copolymer mixture can contain 10 to 90 weight percent of a first block copolymer and 10 to 90 weight percent of a second block copolymer having a larger weight average molecular weight, 20 to 80 weight percent of the first block copolymer and 20 to 80 weight percent of the second block copolymer having the larger weight average molecular weight, or 25 to 75 weight percent of the first block copolymer and 25 to 75 weight percent of the second block copolymer having the larger weight average molecular weight.

If multiple block copolymers with different concentrations of the A block polymeric units are included in the base layer composition, the concentrations can differ by any suitable amount. In some instances, the concentration can vary by at least 20 percent, at least 40 percent, at least 60 percent, at least 80 percent, or at least 100 percent.

The block copolymer mixture can contain 10 to 90 weight percent of a first block copolymer and 10 to 90 weight percent of a second block copolymer having a greater amount of the A block or 20 to 80 weight percent of the first block copolymer and 20 to 80 weight percent of the second block copolymer having the greater amount of the A block or 25 to 75 weight percent of the first block copolymer and 25 to 75 weight percent of the second block copolymer having the greater amount of the A block.

### Random Copolymers

In some embodiments, the provided reflective articles have a base layer that includes at least one random copolymer.

As used herein, the term “random copolymer” refers to a polymeric material that includes at least two different polymeric units (or repeat units) that are covalently bonded to each other in a randomized fashion along the polymer backbone. Like block copolymers, random copolymers include two or more polymeric units that are chemically dissimilar. Moreover, the polymeric units of random copolymers are derived from two or more respective monoethylenically unsaturated monomers, and are associated with different respective glass transition temperatures. However, unlike block copolymers, random copolymers have polymeric units that are not segregated into discrete blocks, but rather homogenously interspersed with each other on a nanoscopic level.

Random copolymers also differ from block copolymers in their macroscopic properties. While block copolymers can microphase separate based on the insolubility of the A and B blocks, random copolymers have a homogenous microstructure. As a result, random copolymers display only a single glass transition temperature, while microphase-separated block copolymers display two or more glass transition temperatures.

The glass transition temperature of a random copolymer generally resides between the glass transition temperatures associated with its respective polymeric units. For example, a random copolymer of methyl methacrylate and n-butyl acrylate has a glass transition temperature residing between that of the corresponding poly(methyl methacrylate) and poly(n-butyl acrylate) homopolymers. If desired, the exact glass transition temperature can be approximated using various theoretical and empirical formulas based on the glass transition temperatures associated with the polymeric units and the relative weight or volume fraction of each component.

The random copolymers described herein include at least a first polymeric unit A and a second polymeric unit B. The A polymeric unit is the “hard,” rigid component, while the B polymeric unit is the “soft,” less rigid component. The A polymeric unit, when reacted to form a homopolymer, has a glass transition temperature of at least 50° C. The B polymeric unit, when reacted to form a homopolymer, has a glass transition temperature no greater than 20° C. In other words, the A polymeric unit is associated with a glass transition temperature of at least 50° C., while the B polymeric unit is associated with a glass transition temperature no greater than 20° C.

In exemplary random copolymers, the A polymeric unit is associated with a glass transition temperature of at least 60° C., at least 80° C., at least 100° C., or at least 120° C., while the B polymeric unit is associated with a glass transition temperature no greater than 10° C., no greater then 0° C., no greater than −5° C., or no greater than −10° C.

The A polymeric units are generally associated with homopolymers that are thermoplastic materials, while the B polymeric units are generally associated with homopolymers that are elastomeric materials. Further, the solubility parameters associated with the A and B polymeric units are sufficiently different that the respective A and B homopolymers would not be miscible in each other. As a result of its randomized polymer architecture, however, the random copolymer exhibits a homogenous microstructure at all compositions.

Exemplary chemical structures and characteristics of the A and B polymeric units are similar to those previously described for the A block and B block polymeric units, and thus shall not be repeated here.

The weight percent of the A polymeric units generally exceeds the weight percent of the B polymeric units in the random copolymer. Higher amounts of the A polymeric unit tends to increase the overall modulus of the random copolymer. At the same time, higher amounts of the A polymeric block also tends to reduce the tackiness of the random copolymer at ambient temperatures. The base layer including the random copolymer may be either tacky or non-tacky. However, it is preferable that the base layer is non-tacky for the same reasons given before concerning base layers that include block copolymers.

The random copolymer typically contains 60 to 95 weight percent of the A polymeric units and 5 to 40 weight percent of the B polymeric units. For example, the block copolymer can contain 60 to 90 weight percent of the A polymeric units and 10 to 40 weight percent of the B polymeric units, 60 to 85 weight percent of the A polymeric units and 15 to 40 weight percent of the B polymeric units, 65 to 95 weight percent of the A polymeric units and 5 to 35 weight percent of the B polymeric units, 65 to 90 weight percent of the A polymeric units and 10 to 35 weight percent of the B polymeric units, 65 to 85 weight percent of the A polymeric units and 15 to 35 weight percent of the B polymeric units, 70 to 95 weight percent of the A polymeric units and 5 to 30 weight percent of the B polymeric units, 70 to 90 weight percent of the A polymeric units and 10 to 20 weight percent of the B polymeric units, or 70 to 85 weight percent of the A polymeric units and 15 to 30 weight percent of the B polymeric units.

Like the block copolymers described previously, the random copolymers can have any suitable molecular weight. Exemplary molecular weights have already been enumerated in detail for block copolymers and similarly apply here for random copolymers. Additionally, random copolymers having low polydispersity are also contemplated. In preferred embodiments, the random copolymer has a polydispersity of 2.0 or less, 1.5 or less, or 1.2 or less.

Suitable methods of making the random copolymers include living polymerization methods, including the living anionic and living free radical polymerization techniques previously described. While the synthesis of block copolymers generally involves sequential addition of the A and B monomers, however, the synthesis of random copolymers generally involves adding the initiator to a stirred solution containing both the A and B monomers or simultaneously introducing both the A and B monomers into a stirred solution of the initiator. Advantageously, these methods tend to produce random copolymers with controlled molecular weight, low polydispersity, and/or high purity. Conventional, non-living, free-radical polymerization techniques may also be used to prepare the random copolymers.

Suitable random copolymers are also commercially available from Dow Chemical Company (Midland, Mich.), BASF SE (Ludwigshafen, Germany), and The Polymer Source, Inc. (Montreal, Canada).

In some embodiments, two or more random copolymers may be included in the base layer compositions described herein. For example, random copolymers having different weight average molecular weights or different compositions of the A and B polymeric units may be used. Optionally, the two or more random copolymers are present as discrete layers within in the base layer. Alternatively, the two or more random copolymers are blended together to provide a homogenous microstructure. If a blend is contemplated, it is preferable that any differences in composition are not so large that the copolymers phase separate from each other. Advantageously, a combination of two or more random copolymers can be used to tailor the shear strength of the base layer composition.

In some embodiments, the differences in molecular weight and/or differences in composition of the two or more random copolymers are similar to those previously enumerated with respect to block copolymers. As such, this description shall not be repeated here.

### Metallic Components

The provided reflective articles comprise one or more metallic layers. Besides providing a high degree of reflectivity, such articles can also provide manufacturing flexibility. Optionally, the metallic layer may be applied onto a relatively thin organic tie layer or inorganic tie layer, which is in turn situated on a polymeric base layer.

The metallic layers contemplated for the provided reflective articles have smooth, reflective metal surfaces that can also be specular surfaces. As used herein, “specular surfaces” refer to surfaces that induce a mirror-like reflection of light in which the direction of incoming light and the direction of outgoing light form the same angle with respect to the surface normal. Any reflective metal may be used for this purpose, although preferred metals include silver, gold, aluminum, copper, nickel, and titanium. Of these, silver, aluminum and gold are particularly preferred.

Optionally, one or more layers can also be added to alleviate the effects of corrosion on the reflective article. For example, a copper layer may be deposited onto the back side of a silver layer for use as a sacrificial anode to reduce corrosion of adjacent metallic layers.

A metallic layer can be deposited on the base layer using a variety of methods. Examples of suitable deposition techniques include physical vapor deposition via sputter coating, evaporation via e-beam or thermal methods, ion-assisted e-beam evaporation and combinations thereof. Metallic or ceramic mask or shuttering features may be used to limit the deposition to certain areas if so desired.

One particularly suitable deposition technique for forming metallic layers is physical vapor deposition (PVD) by sputtering. In this technique, atoms of the target are ejected by high-energy particle bombardment so that they can impinge onto a substrate to form a thin film. The high-energy particles used in sputter-deposition are generated by a glow discharge, or a self-sustaining plasma created by applying, for example, an electromagnetic field to argon gas.

In one exemplary method, the deposition process continues for a sufficient duration to build up a suitable layer thickness of the metallic layer on the base layer, thereby forming the metallic layer. As another option, other metals besides silver may be used. For example, metallic layers composed of a different metal may be similarly deposited by using a suitable target composed of that metal.

### Reflective Articles and Assemblies

Reflective articles are provided that include at least one of the block copolymer or random copolymer compositions described above, along with a metallic composition. All figures referred to herein are for illustrative purposes only and not necessarily drawn to scale.

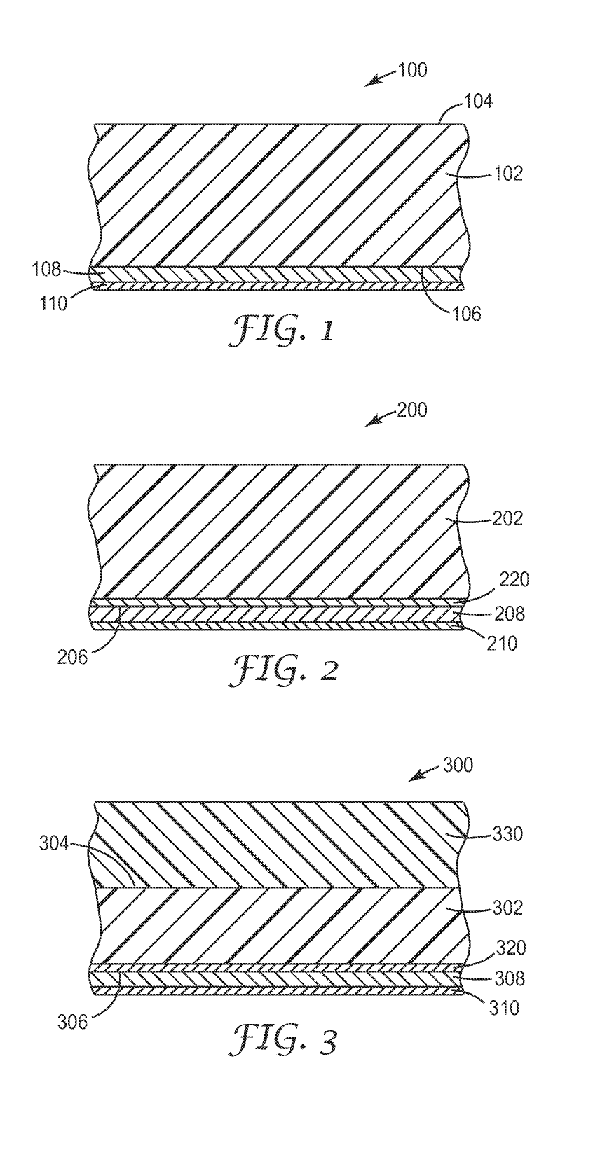

A reflective article according to one embodiment is shown in FIG. 1 and broadly denoted by the numeral 100. As shown, the article 100 includes a base layer 102 having a first surface 104 and a second surface 106.

The base layer 102 comprises a triblock copolymer that is non-tacky (non-adhesive) at ambient temperatures. The block copolymer has at least two endblock polymeric units, each derived from a first monoethylenically unsaturated monomer comprising a methacrylate, acrylate, styrene, or combination thereof. The block copolymer has one midblock polymeric unit that is derived from a second monoethylenically unsaturated monomer comprising a methacrylate, acrylate, vinyl ester, or combination thereof. Each endblock has a glass transition temperature of at least 50 degrees Celsius, while the midblock has a glass transition temperature no greater than 20 degrees Celsius.

The base layer 102 may alternatively comprise a block copolymer/homopolymer blend. For example, the base layer 102 may include an A-B-A triblock copolymer blended with a homopolymer that is soluble in either the A or B block. Optionally, the homopolymer has a polymeric unit identical to either the A or B block. The addition of one or more homopolymers to the block copolymer composition can be advantageously used either to plasticize or to harden one or both blocks. In preferred embodiments, the block copolymer contains a poly(methyl methacrylate) A block and a poly(butyl acrylate) B block, and is blended with a poly(methyl methacrylate) homopolymer.

Advantageously, blending poly(methyl methacrylate) homopolymer with poly(methyl methacrylate)-poly(butyl acrylate) block copolymers allows the hardness of the base layer 102 to be tailored to the desired application. As a further advantage, blending with poly(methyl methacrylate) provides this control over hardness without significantly degrading the clarity or processibility of the overall composition. Preferably, the homopolymer/block copolymer blend has an overall poly(methyl methacrylate) composition of at least 30 percent, at least 40 percent, or at least 50 percent, based on the overall weight of the blend. Preferably, the homopolymer/block copolymer blend has an overall poly(methyl methacrylate) composition no greater than 95 percent, no greater than 90 percent, or no greater than 80 percent, based on the overall weight of the blend.

Particularly suitable non-tacky block copolymers include poly(methyl methacrylate)-poly(n-butyl acrylate)-poly(methyl methacrylate) (25:50:25) triblock copolymers. These materials were previously available under the trade designation LA POLYMER from Kuraray Co., LTD, and are available as of the filing date of this application under the brand name KURARITY from the same company, as of August 2010.

Optionally, the block copolymer may be combined with a suitable ultraviolet light absorber to enhance the stability of the base layer 102. In some embodiments, the block copolymer contains an ultraviolet light absorber. In some embodiments, the block copolymer contains an amount of the ultraviolet light absorber ranging from 0.5 percent to 3.0 percent by weight, based on the total weight of the block copolymer and absorber. It is to be noted, however, that the block copolymer need not contain any ultraviolet light absorbers. Using a composition free of any ultraviolet light absorbers can be advantageous because these absorbers can segregate to the surfaces of the base layer 102 and interfere with adhesion to adjacent layers.

As a further option, the block copolymer may be combined with one or more nanofillers to adjust the modulus of the base layer 102. For example, a nanofiller such as silicon dioxide or zirconium dioxide can be uniformly dispersed in the block copolymer to increase the overall stiffness or hardness of the article 100. In preferred embodiments, the nanofiller is surface-modified as to be compatible with the polymer matrix. This can help avoid making porous materials that scatter light upon tentering.

The base layer 102 may also comprise a random copolymer having a first polymeric unit with a relatively high T_{g} and second polymeric unit with a relatively low T_{g}. In this embodiment, the first polymeric unit derives from a first monoethylenically unsaturated monomer comprising a methacrylate, acrylate, styrene, or combination thereof and associated with a glass transition temperature of at least 50 degrees Celsius and the second polymeric unit derived from a second monoethylenically unsaturated monomer comprising a methacrylate, acrylate, vinyl ester, or combination thereof and associated with a glass transition temperature no greater than 20 degrees Celsius.

In particularly preferred random copolymers, the first polymeric unit is methyl methacrylate and the second polymeric unit is butyl acrylate. It is preferable that the random copolymer has a methyl methacrylate composition of at least 50 percent, at least 60 percent, at least 70 percent, or at least 80 percent, based on the overall weight of the random copolymer. It is further preferable that the random copolymer has a methyl methacrylate composition of at most 80 percent, at most 85 percent, at most 90 percent, or at most 95 percent, based on the overall weight of the random copolymer.

In some embodiments, the base layer 102 has a thickness of at least 0.25 micrometers, at least 0.4 micrometers, at least 0.6 micrometers, at least 0.8 micrometers, at least 1 micrometer, at least 5 micrometers, at least 10 micrometers, at least 50 micrometers, or at least 60 micrometers. Additionally, in some embodiments, the base layer 102 has a thickness no greater than 200 micrometers, no greater than 150 micrometers or no greater than 100 micrometers, no greater than 50 micrometers, no greater than 25 micrometers, no greater than 10 micrometers, no greater than 5 micrometers, or no greater than 1 micrometer.

Extending across the second surface 106 of the base layer 102 is a metallic layer 108. In exemplary embodiments, the metallic layer 108 comprises elemental silver. As noted, however, other metals such as aluminum can also be used. Preferably, the interface between the metallic layer 108 and the base layer 102 is sufficiently smooth that the metallic layer 108 provides a specular (mirrored) surface.

The metallic layer 108 need not extend across the entire second surface 106 of the base layer 102. If desired, the base layer 102 can be masked during the deposition process such that the metallic layer 108 is applied onto only a pre-determined portion of the base layer 102. Patterned deposition of the metallic layer 108 onto the base layer 102 is also possible.

Optionally and as shown, a second metallic layer 110 contacts and extends across the first metallic layer 108. In exemplary embodiments, the second metallic layer 110 comprises elemental copper. Use of a copper layer that acts as a sacrificial anode can provide a reflective article with enhanced corrosion-resistance and outdoor weatherability. As another approach, a relatively inert metal alloy such as Inconel (an iron-nickel alloy) can also be used to enhance corrosion resistance.

The reflective metal layer is preferably thick enough to reflect the desired amount of the solar spectrum of light. The preferred thickness can vary depending on the composition of the metallic layer 108,110. For example, the metallic layer 108,110 is preferably at least about 75 nanometers to about 100 nanometers thick for metals such as silver, aluminum, and gold, and preferably at least about 20 nanometers or at least about 30 nanometers thick for metals such as copper, nickel, and titanium.

In some embodiments, one or both of the metallic layers 108,110 have a thickness of at least 25 nanometers, at least 50 nanometers, at least 75 nanometers, at least 90 nanometers, or at least 100 nanometers. Additionally, in some embodiments, one or both of the metallic layers 108,110 have a thickness no greater than 100 nanometers, no greater than 110 nanometers, no greater than 125 nanometers, no greater than 150 nanometers, no greater than 200 nanometers, no greater than 300 nanometers, no greater than 400 nanometers, or no greater than 500 nanometers.

As described previously, one or both of the metallic layers 108,110 can be deposited using any of a number of methods known in the art, including chemical vapor deposition, physical vapor deposition, and evaporation. Although not shown in the figures, three or more metallic layers may be used.

Optionally but not shown, the reflective article 100 is adhered to a supporting substrate (or back plate) to impart a suitable shape to the reflective article 100. Article 100 can be adhered to a substrate using, for example, a suitable adhesive. In some embodiments, the adhesive is a pressure sensitive adhesive (PSA). As used herein, the term “pressure sensitive adhesive” refers to an adhesive that exhibits aggressive and persistent tack, adhesion to a substrate with no more than finger pressure, and sufficient cohesive strength to be removable from the substrate. Exemplary pressure sensitive adhesives include those described in PCT Publication No. WO 2009/146227 (Joseph, et al.).

Suitable substrates generally share certain characteristics. First, the substrate should be sufficiently smooth that texture in the substrate is not transmitted through the adhesive/metal/polymer stack. This, in turn, is advantageous because it: (1) allows for an optically accurate mirror, (2) maintains physical integrity of the metal by eliminating channels for ingress of reactive species that might corrode the metal or degrade the adhesive, and (3) provides controlled and defined stress concentrations within the reflective film-substrate stack. Second, the substrate is preferably nonreactive with the reflective mirror stack to prevent corrosion. Third, the substrate preferably has a surface to which the adhesive durably adheres.

Exemplary substrates for reflective films, along with associated options and advantages, are described in PCT Publication Nos. WO04114419 (Schripsema), and WO03022578 (Johnston et al.); U.S. Publication Nos. 2010/0186336 (Valente, et al.) and 2009/0101195 (Reynolds, et al.); and U.S. Pat. No. 7,343,913 (Neidermeyer).

As a further option, the substrate may include a release surface to allow the reflective article 100 and pressure sensitive adhesive to be easily removed and transferred to another substrate. For example, the exposed surface of the metallic layer 110 in FIG. 1 may be coated with a pressure sensitive adhesive and the pressure sensitive adhesive temporarily secured to a silicone-coated release liner. Such a configuration can then be conveniently packaged for transport, storage, and consumer use.

FIG. 2 shows a reflective article 200 according to another embodiment. Like the article 100, the article 200 has a base layer 202 and metallic layers 208,210 extending across a second surface 206 of the base layer 202. Unlike article 100, however, the article 200 includes a tie layer 220 interposed between the second surface 206 of the base layer 202 and a first surface of the uppermost metallic layer 208. In some embodiments, the tie layer 220 comprises a metal oxide such as aluminum oxide, copper oxide, titanium dioxide, silicon dioxide, or combinations thereof. As a tie layer 220, titanium dioxide was found to provide surprisingly high resistance to delamination in dry peel and wet peel testing. Further options and advantages of metal oxide tie layers are described in U.S. Pat. No. 5,361,172 (Schissel et al.).

It is preferable that the tie layer 220 has an overall thickness of at least 0.1 nanometers, at least 0.25 nanometers, at least 0.5 nanometers, or at least 1 nanometer. It is further preferable that the tie layer 220 has an overall thickness no greater than 2 nanometers, no greater than 5 nanometers, no greater than 7 nanometers, or no greater than 10 nanometers.

FIG. 3 shows a reflective article 300 according to yet another embodiment. Article 300 is similar to article 200 in that it includes a base layer 302, a tie layer 320 contacting and extending across the second surface 306 of the base layer 302, and successive metallic layers 308,310 extending across an opposing surface of the tie layer 320. Unlike the articles 100,200, however, the article 300 has a top layer 330 contacting and extending across the first surface 304 of the base layer 302. Preferably, the top layer 330 is a polymeric layer having high surface hardness, excellent light transmission and weatherability, such as a layer of poly(methyl methacrylate). Optionally, the top layer 330 is laminated or solvent-cast onto the underlying base layer 302, or vice-versa.

The top layer 330 can have any thickness suitable for the particular application at hand. For solar reflective films, thicknesses ranging from 50 to 150 micrometers are preferred to provide both resistance to weathering and adequate mechanical flexibility. Also, like the base layer 102, the top layer 330 may be mixed with one or more nanofillers to adjust the properties of the top layer 330.

The presence of a top layer 330 can enhance the strength of the overall article 300. With the top layer 330 providing structural support, the base layer 302 can be made quite thin, serving as an “organic tie layer” between the top layer 330 and the underlying layers 320,308,310. In the configuration shown in FIG. 3, the base layer 302 preferably has a thickness of at least 0.25 micrometers, at least 0.5 micrometers, at least 0.8 micrometers, at least 1 micrometer, at least 1.5 micrometers, or at least 2 micrometers. Preferably, the base layer 302 has a thickness no greater than 4 micrometers, no greater than 5 micrometers, or no greater than 7 micrometers.

The thin base layer 302 was found to provide surprisingly robust reflective films. The base layer 302 appears to maintain adhesion between the poly(methyl methacrylate) and the metal by diffusing stress during environmental exposure. The stress diffusive properties of the disclosed block and random copolymers were found to be surprisingly effective in preventing delamination in the samples tested. Temperatures at the interface during deposition significantly exceed the T_{g} of the B block of the base layer 302, which may permit rearrangement of the polymer at the interface to relax stresses induced by (1) temperature gradients across the stack, (2) unrelieved stresses in the deposited film, and (3) degradation reactions in base layer 302 during deposition.

In a high vacuum process such as physical vapor deposition, vacuum ultraviolet radiation (having wavelengths below 165 nanometers) can induce chain scission at the surface of a poly(methyl methacrylate) top layer. This chain scission can, in turn, adversely affect the ability of the poly(methyl methacrylate) to adhere to adjacent metal layers deposited using such a process. The base layer 302, generally prepared in a non-vacuum process prior to metal deposition, can advantageously protect the poly(methyl methacrylate) surface. Since the base layer 302 is less susceptible to chain scission, it can insulate the poly(methyl methacrylate) surface from the damaging effects of vacuum ultraviolet radiation.

Overall, the reflective article 300 is capable of providing high hardness and weatherability, excellent coatability (or sticking coefficient), and vacuum ultraviolet radiation stability. In some embodiments, additives such as ultraviolet stabilizers and antioxidants are included in the top layer 330, while the base layer 302 is kept substantially free of these additives to avoid adhesion issues that could arise from segregation of ultraviolet stabilizers, antioxidants and other additives to the surface to be coated. In some embodiments, the top layer 330 is comprised of poly(methyl methacrylate) and contains an amount of an ultraviolet light absorber ranging from 0.5 percent to 3.0 percent by weight, based on the total weight of the poly(methyl methacrylate) and absorber.

The base layer 302 provides additional benefits that promote adhesion during environmental exposure to temperature and humidity fluctuations. The rubbery B block permits diffusion of stress due to differential expansion in the stack associated with changes in temperature and humidity. Additionally, the disclosed block and random copolymers are also substantially less water permeable than poly(methyl methacrylate). Water adsorption can result in chemical or physical reduction in adhesive contact between the metal and adjacent polymer layer.

Other aspects of articles 200 and 300 are similar to those previously described for article 100 and shall not be repeated.

Optionally, the article 100,200,300 is part of an assembly in which the article 100,200,300 is rigidly held by a suitable underlying support structure. For example, the article 100,200,300 can be comprised in one of the many mirror panel assemblies described in co-pending and co-owned provisional U.S. Patent Application Ser. No. 61/239,265 (Cosgrove, et al.), filed on Sep. 2, 2009.

### EXAMPLES

These examples are merely for illustrative purposes and are not meant to be limiting on the scope of the appended claims. All parts, percentages, ratios, and the like in the examples and the rest of the specification are by weight, unless noted otherwise. Solvents and other reagents used were obtained from Sigma-Aldrich Chemical Company (Milwaukee, Wis.) unless otherwise noted.

### Specimen Preparation

The material used for the layer corresponding to the top layer of the present invention was a conventional 3.5 mil (89 micrometer) poly(methyl methacrylate) (PMMA) film of the type commonly used for sign materials and the like, manufactured in-house by extrusion followed by biaxial stretching. The film was made from a resin designated as CP-80 (Plaskolite, Inc., Columbus, Ohio) which has a minimum of impurities and provides a very clear film. The film also contained about 2.5% by weight of the UV stabilizer TINUVIN brand 1577 (Ciba, a Division of BASF Corporation, Florham Park, N.J.). This film was used as a substrate upon which each specimen was built.

Coating solutions were prepared by dissolving each of the resin materials from Table 1 in toluene at 20 wt % solids. For each, solvent and polymer were charged to a glass bottle, which was rotated overnight on a motorized rotor or on a shear blade mixer. A clear solution (by visual inspection) was achieved within a few hours. The solution so obtained remained stable and fully dissolved for months.

TABLE 1
Glossary of Materials

| Material | Description |
|---|---|
| LA POLYMER 2140 | A poly(methyl methacrylate)-poly(n-butyl acrylate)-poly(methyl |
| (KARARITY brand) | methacrylate) triblock copolymer that is available from Kuraray Co., |
| | LTD (Tokyo, Japan) with a weight average molecular weight of |
| | about 80,000 grams/mole. This copolymer contains 24 weight |
| | percent poly(methyl methacrylate) and 76 weight percent poly(n- |
| | butyl acrylate). |
| LA POLYMER 2250 | A poly(methyl methacrylate)-poly(n-butyl acrylate)-poly(methyl |
| (KARARITY brand) | methacrylate) triblock copolymer that is available from Kuraray Co., |
| | LTD (Tokyo, Japan) with a weight average molecular weight of |
| | about 80,000 grams/mole. This copolymer contains 33 weight |
| | percent poly(methyl methacrylate) and 67 weight percent poly(n- |
| | butyl acrylate). |
| LA POLYMER 410 | A poly(methyl methacrylate)-poly(n-butyl acrylate)-poly(methyl |
| (KARARITY brand) | methacrylate) triblock copolymer that is available from Kuraray |
| | Co., LTD (Tokyo, Japan) with a weight average molecular weight of |
| | about 160,000 grams/mole. This copolymer contains 21 weight |
| | percent poly(methyl methacrylate) and 79 weight percent poly(n- |
| | butyl acrylate). |
| LA POLYMER 4285 | A poly(methyl methacrylate)-poly(n-butyl acrylate)-poly(methyl |
| (KARARITY brand) | methacrylate) triblock copolymer that is available from Kuraray Co., |
| | LTD (Tokyo, Japan) with a weight average molecular weight of |
| | about 75000 grams/mole. This copolymer contains 51 weight |
| | percent poly(methyl methacrylate) and 49 weight percent poly(n- |
| | butyl acrylate). |
| B48S | A poly(methyl methacrylate-co-n-butyl acrylate) random copolymer |
| 80:20 PMMA:BA | that is manufactured by Rohm & Haas Co. and is available from |
| | Sigma-Aldrich Co. (Milwaukee, WI) as a solid or as a 40% solids |
| | solution in toluene. This copolymer contains 80 weight percent |
| | methyl methacrylate and 20 weight percent n-butyl acrylate. |

The PMMA film was cut into 12 inch (30.5 centimeter) square coupons. For each specimen, a layer corresponding to the base layer of the present invention was coated onto the coupon by hand using a flat glass Mayer rod coater. The top edge of the coupon was affixed to the flat glass of the coater using box sealing tape. 20-40 ml of coating solution (20 weight percent solids) was deposited close to the top edge, and the Mayer rod was passed over the specimen to evenly spread coating solution on the substrate. A #4 Mayer rod was used so as to coat no more than a 0.4 mil (10 micrometer) wet coating thickness. The coated PMMA substrate was than dried in a solvent-rated oven (with air circulation) for at least 30 minutes at 70° C. to completely remove solvent from the coating. Each coating was approximately 2 micrometers in dry thickness. Each specimen was inspected for interference color or coating non-uniformity and rejected if such defects were found.

Dried, coated specimens were then vapor coated in a high vacuum (low pressure) physical vapor deposition (PVD) coater in order to add the metallic layer and optionally the tie layer of the present invention. Up to six specimens were loaded at a time, in the rotating dome of the PVD coater, on six 12 inch (30.5 centimeter) diameter specimen holders, which were located near the edge of the dome and configured at 45 degree angles facing the point source. The point source had 4 pocket e-beam crucibles, each of 1.5 inch (3.8 centimeter) diameter. The specimens were loaded with the copolymer base layer facing toward the point deposition source. As is common for PVD coaters of this type, the coating dome was rotated on its central axis and each holder was also rotated on its individual central axis. This double rotation served to ensure uniform deposition of metal and metal oxides vapors from the hot point source.

Once the specimens were loaded, the coater was evacuated, first using a mechanical roughing pump and then using a cryogenic pump to reduce pressure to one millionth of a ton. At this pressure, if the specimens were to receive a tie layer, the electron beam gun was turned on to pre-heat TiO₂ pellets in the first of the four crucibles. When an appropriate vapor pressure of TiO₂ was achieved, the shield between the heated crucible and the specimen holders was removed, allowing TiO₂ vapors to deposit on the rotating specimens. A 5 nm thick TiO₂ film was deposited, at the rate of 5 Angstroms/second, on the surface of the specimens. The rate of deposition and the thickness was measured using an INFICON brand crystal rate/thickness monitoring sensor and controller (Inficon, East Syracuse, N.Y.).

After depositing 5 nm of TiO₂, the shield was automatically inserted by the thickness monitoring system to completely stop vapors from reaching the specimens. Without breaking vacuum, the second crucible, holding 99.999% purity silver wire pieces, was moved in to place. The same procedure as that for TiO₂ deposition was repeated to deposit a 90 nm thick silver layer over the TiO₂ layer. Then a third crucible holding copper wire was moved into place, and a 30 nm thick copper layer was deposited over the silver layer. Finally, the coater was backfilled slowly with dry nitrogen, and the specimens were carefully removed.

Specimens not intended to receive a tie layer were prepared analogously, with the first deposition of TiO₂ omitted.

### Dry Adhesion Test

The dry adhesion tape test was performed on several specimens. Specimens were prepared using each of the five base layer polymers shown in Table 1, above. None of the specimens included a tie layer. 19 millimeter wide SCOTCH MAGIC brand tape, Catalogue #810 (3M, St. Paul, Minn.) was used for the testing, as follows. A 6 inch (15 centimeter) long strip of tape was firmly adhered to the Copper surface of a specimen. Air bubbles were removed using a hand roller. After approximately 5 minutes, the tape was manually peeled off, at an angle between 120 and 170 degrees, and at a speed of about 2 ft/min (60 centimeters/minute). Metal removal was measured as a percent of total surface area. Each of the specimens made with each of the five base layer polymers showed 0% metal removal.

### Examples 1-16

### Wet Adhesion Peel Testing

Specimens were prepared as described above, using four of the five base layer polymers listed in Table 1. For each base layer polymer, specimens were prepared both with and without inclusion of a TiO₂ tie layer. Two identically-prepared specimens of each type were tested using the wet adhesion peel test, as described here.

From each specimen was cut a ¾ inch (1.9 centimeter) wide and at least 6 inch (15 centimeter) long test strip. Each test strip was laminated to an aluminum plate, with the copper surface facing the plate, using a 1 mil (25.4 micrometer) thick application of a pressure sensitive adhesive. The choice of adhesive is not critical, but in these Examples the adhesive used was RD1263 (3M, St. Paul, Minn.). The adhesive was first coated onto a PET release liner. The liner bearing the adhesive was then applied to the test specimen using a hand roller or a laboratory-scale laminator. The release liner was then peeled away and the construction was laminated to the aluminum plate. Each laminated test strip was pre-scored down the center in the long dimension using an appliance having two sharp knife blades set ½ inch (1.3 centimeters) apart. Each aluminum plate bearing a test strip was than soaked in a tank of deionized water at room temperature, to allow moisture to penetrate and potentially weaken the several interfaces within the test strip.

After 24 hours, each plate was removed from the water bath and surface-dried with an absorbent wipe. Using a sharp blade or utility knife the polymer layer was separated from the metal or metal oxide in contact with it at one end of the test strip, thus initiating a peel. The aluminum plate was mounted horizontally on the movable stage of an INSTRON brand peel tester (Instron, Norwood, Mass.). The free polymer end created with the sharp blade or utility knife was mounted in the jaws of a crosshead and pulled up at a 90 degree angle to the aluminum plate at speed of 6 ft/min (1.8 m/min). The stage was translated horizontally in conjunction with the crosshead movement in order to maintain the 90 degree peel angle. In the early stage of each peel, the failure interface “jumped” to the weakest interface if it was not already at the weakest interface as a result of the blade incision. The peel strength was recorded in terms of the maximum load, the minimum load, the average load, and the standard deviation of the load detected by the INSTRON brand load cell during the peel, neglecting the initial portion of the peel during which the stable peeling mode becomes established, and load may vary significantly. Test strips were inspected after the peel to determine which interface failed. The results are shown in Table 2.

TABLE 2
Wet Adhesion Peel Test Results

| | | | | Max. | Min. | Average | St. Dev. |
|---|---|---|---|---|---|---|---|
| | Base Layer | TiO₂ Tie | Failed | Load | Load | Load | Load |
| Example | Polymer | Layer? | Interface | lbf | lbf | lbf | lbf |
| 1 | LA 2250 | No | Ag- Base | 1.652 | 0.906 | 1.35 | 0.13 |
| | | | Layer | | | | |
| 2 | LA 2250 | No | Ag- Base | 1.590 | 0.801 | 1.33 | 0.14 |
| | | | Layer | | | | |
| 3 | LA 2250 | Yes | Cu- | 1.333 | 0.676 | 1.13 | 0.14 |
| | | | Adhesive | | | | |
| 4 | LA 2250 | Yes | Cu- | 1.368 | 0.736 | 1.09 | 0.13 |
| | | | Adhesive | | | | |
| 5 | LA 4285 | No | Ag- Base | 1.117 | 0.661 | 0.97 | 0.08 |
| | | | Layer | | | | |
| 6 | LA 4285 | No | Ag- Base | 1.334 | 1.010 | 1.18 | 0.05 |
| | | | Layer | | | | |
| 7 | LA 4285 | Yes | Cu- | 1.482 | 1.084 | 1.29 | 0.05 |
| | | | Adhesive | | | | |
| 8 | LA 4285 | Yes | Cu- | 1.350 | 1.056 | 1.22 | 0.06 |
| | | | Adhesive | | | | |
| 9 | LA 2140 | No | Ag- Base | 1.567 | 1.198 | 1.40 | 0.07 |
| | | | Layer | | | | |
| 10 | LA 2140 | No | Ag- Base | 1.587 | 1.028 | 1.44 | 0.11 |
| | | | Layer | | | | |
| 11 | LA 2140 | Yes | Cu- | 1.570 | 1.022 | 1.39 | 0.11 |
| | | | Adhesive | | | | |
| 12 | LA 2140 | Yes | Cu- | 1.588 | 0.895 | 1.40 | 0.13 |
| | | | Adhesive | | | | |
| 13 | R&H 80:20 | No | Ag- Base | 1.240 | 0.403 | 0.90 | 0.14 |
| | | | Layer | | | | |
| 14 | R&H 80:20 | No | Ag- Base | 1.571 | 0.430 | 1.07 | 0.20 |
| | | | Layer | | | | |
| 15 | R&H 80:20 | Yes | Cu- | 1.590 | 1.230 | 1.37 | 0.07 |
| | | | Adhesive | | | | |
| 16 | R&H 80:20 | Yes | Cu- | 1.598 | 1.237 | 1.34 | 0.05 |
| | | | Adhesive | | | | |

### Examples 17-64

### Wet Adhesion Peel Testing after Outdoor Exposure

Specimens were prepared as described above, using four of the five base layer polymers listed in Table 1. For each base layer polymer, specimens were prepared both with and without inclusion of a TiO₂ tie layer. For each of these eight specimen types, six test strips were cut, each test strip being ¾ inch (1.9 centimeters) wide and at least 6 inch (15 centimeters) long. Each test strip was laminated to an aluminum plate, with the copper surface facing the plate, using a 1 mil (25.4 micrometer) thick application of the RD1263 (3M, St. Paul, Minn.) adhesive as cited in previous Examples. Each laminated test strip was pre-scored down the center in the long dimension using an appliance having two sharp knife blades set ½ inch (1.3 centimeters) apart.

For each specimen type, two of the six laminated test strips were set aside, and four were mounted on an exposure deck on the roof of a building. The exposure deck was configured to face south, and was angled to maximize solar exposure. For each specimen type, two of the four laminated test strips were left on the exposure deck for 16 days and then removed, and two were left on the exposure deck for 28 days and then removed, in order to assess their behavior when exposed to sunlight and variable outdoor humidity in the absence of any edge protection.

Two identically-prepared specimens of each type were tested using the wet adhesion peel test, as described previously for Examples 1-16. The results are shown in Table 3. The column labeled “Failure Mode” indicates the percentages of the entire test strip which experienced failure at a given interface, after 28 days exposure, where “P” corresponds to the interface between polymer and metal or metal oxide, “M” corresponds to the interface between metallic layer and adhesive, and “A” corresponds to the interface between the adhesive and the aluminum plate. Hence, the most desirable result is P=0 and M+A=100, with no preference given among the various possible distributions between “M” and “A”.

TABLE 3
Wet Adhesion Peel Test Results After Outdoor Exposure

| | | | Outdoor | Average | St. Dev. | Change from | |
|---|---|---|---|---|---|---|---|
| | Base Layer | TiO₂ Tie | Exposure | Load | Load | initial | Failure |
| Ex. | Polymer | Layer? | Days | lbf | lbf | lbf | Mode |
| 17 | LA 2250 | No | 0 | 1.35 | 0.13 | N/A | |
| 18 | LA 2250 | No | 0 | 1.33 | 0.14 | N/A | |
| 19 | LA 2250 | Yes | 0 | 1.13 | 0.14 | N/A | |
| 20 | LA 2250 | Yes | 0 | 1.09 | 0.13 | N/A | |
| 21 | LA 2250 | No | 16 | 1.29 | 0.13 | −0.06 | |
| 22 | LA 2250 | No | 16 | 1.21 | 0.13 | −0.12 | |
| 23 | LA 2250 | Yes | 16 | 1.07 | 0.10 | −0.06 | |
| 24 | LA 2250 | Yes | 16 | 0.97 | 0.10 | −0.12 | |
| 25 | LA 2250 | No | 28 | 0.74 | 0.19 | −0.61 | P: 95 M: 5 |
| 26 | LA 2250 | No | 28 | 0.87 | 0.21 | −0.46 | P: 95 M: 5 |
| 27 | LA 2250 | Yes | 28 | 1.04 | 0.08 | −0.09 | M: 100 |
| 28 | LA 2250 | Yes | 28 | 1.03 | 0.10 | −0.06 | M: 100 |
| 29 | LA 4285 | No | 0 | 0.97 | 0.08 | N/A | |
| 30 | LA 4285 | No | 0 | 1.18 | 0.05 | N/A | |
| 31 | LA 4285 | Yes | 0 | 1.29 | 0.05 | N/A | |
| 32 | LA 4285 | Yes | 0 | 1.22 | 0.06 | N/A | |
| 33 | LA 4285 | No | 16 | 0.77 | 0.45 | −0.20 | |
| 34 | LA 4285 | No | 16 | 0.29 | 0.04 | −0.89 | |
| 35 | LA 4285 | Yes | 16 | 1.48 | 0.07 | +0.19 | |
| 36 | LA 4285 | Yes | 16 | 1.33 | 0.06 | +0.11 | |
| 37 | LA 4285 | No | 28 | | | | A: 98 M: 2 |
| 38 | LA 4285 | No | 28 | 0.20 | 0.03 | −0.98 | A: 98 M: 2 |
| 39 | LA 4285 | Yes | 28 | 1.73 | 0.11 | +0.44 | M: 100 |
| 40 | LA 4285 | Yes | 28 | 1.72 | 0.13 | +0.50 | M: 100 |
| 41 | LA 2140 | No | 0 | 1.40 | 0.07 | N/A | |
| 42 | LA 2140 | No | 0 | 1.44 | 0.11 | N/A | |
| 43 | LA 2140 | Yes | 0 | 1.39 | 0.11 | N/A | |
| 44 | LA 2140 | Yes | 0 | 1.40 | 0.13 | N/A | |
| 45 | LA 2140 | No | 16 | 1.15 | 0.07 | −0.25 | |
| 46 | LA 2140 | No | 16 | 1.13 | 0.06 | −0.31 | |
| 47 | LA 2140 | Yes | 16 | 1.22 | 0.14 | −0.17 | |
| 48 | LA 2140 | Yes | 16 | 1.20 | 0.08 | −0.20 | |
| 49 | LA 2140 | No | 28 | 0.91 | 0.05 | −0.49 | A: 98 M: 2 |
| 50 | LA 2140 | No | 28 | 0.87 | 0.05 | −0.57 | A: 98 M: 2 |
| 51 | LA 2140 | Yes | 28 | 0.95 | 0.11 | −0.44 | M: 100 |
| 52 | LA 2140 | Yes | 28 | 0.99 | 0.08 | −0.41 | M: 100 |
| 53 | R&H 80:20 | No | 0 | 0.90 | 0.14 | N/A | |
| 54 | R&H 80:20 | No | 0 | 1.07 | 0.20 | N/A | |
| 55 | R&H 80:20 | Yes | 0 | 1.37 | 0.07 | N/A | |
| 56 | R&H 80:20 | Yes | 0 | 1.34 | 0.05 | N/A | |
| 57 | R&H 80:20 | No | 16 | 1.14 | 0.21 | +0.24 | |
| 58 | R&H 80:20 | No | 16 | 0.92 | 0.13 | −0.15 | |
| 59 | R&H 80:20 | Yes | 16 | 0.39 | 0.06 | −0.98 | |
| 60 | R&H 80:20 | Yes | 16 | 0.44 | 0.07 | −0.90 | |
| 61 | R&H 80:20 | No | 28 | 0.50 | 0.09 | −0.40 | P: 100 |
| 62 | R&H 80:20 | No | 28 | 0.50 | 0.08 | −0.57 | P: 100 |
| 63 | R&H 80:20 | Yes | 28 | 1.10 | 0.34 | −0.27 | P: 95 M: 5 |
| 64 | R&H 80:20 | Yes | 28 | 0.93 | 0.21 | −0.41 | P: 95 M: 5 |

### Examples 65-69

### Polymer Blends

It is sometimes desirable to customize certain properties of the reflective articles of the present invention, such as hardness, web handling, and others, by modifying the polymers used for the base layer. It could be desirable to do so by blending PMMA homopolymer with the polymers shown in Table 1. Two concerns when doing such blending would be the optical transmission (lack of haze) of the polymer blend base layer, and the peel adhesion.

For each of Examples 65 and 67-69, films were prepared as follows. PMMA resin CP-40 (Plaskolite, Inc., Columbus, Ohio) having 2.5 wt % TINUVIN brand 1577 was dissolved in toluene alone or as a blend with one of the block copolymers shown in Table 1. The ratio by weight for the blends was 90:10 PMMA:Block copolymer. Each solution was than coated using a Mayer rod as described in previous Examples onto a release liner and dried in a solvent rated oven at 70° C. for 30 min. Coated film was then removed from the release liner for testing.

For Example 66, LAT 735L film (Kuraray Co., LTD, Tokyo, Japan), which is believed to be a film made from a PMMA block copolymer similar to those in Table 1, was used. Both 0.1 millimeter and 0.2 millimeter thick specimens were tested.

Optical transmission measurements were performed on all five films using a LAMBDA brand 900 UV/VIS/NIR spectrometer (PerkinElmer, Waltham, Mass.). All films displayed a relatively flat transmission between 500 and 1600 nm, with two small (less than 1%) dips in the regions around 1200 and 1400 nm. Dry peel adhesion testing was performed as described previously. For dry peel adhesion testing, the films were vapor coated as described in previous Examples with about 5 nm of TiO₂, 100 nm of silver and 30 nm of copper. The percent of the area initially covered by the adhesive tape from which silver was removed was recorded. 0% silver removal indicates excellent dry adhesion, and 100% silver removal indicates poor dry adhesion. Results are shown in Table 4.

TABLE 4
Optical Transmission and Dry Peel Adhesion Test Results

| | | | % Silver |
|---|---|---|---|
| Example | Composition | Transmission | Removal |
| 65 | PMMA | 93% | 100% |
| 66 | LAT 735L | 93% | 0% |
| 67 | 90:10 PMMA:LA2140 | 92% | 0% |
| 68 | 90:10 PMMA:LA2250 | 92% | 10% |
| 69 | 90:10 PMMA:LA410 | 92% | 90% |

### Examples 70-73

### Continuous Process

LA 4825 base layer polymer was selected for use in Examples demonstrating the ability to make articles of the current invention by roll-to-roll, or “continuous” processing techniques. Three coating solutions were prepared, at 4 wt %, 12 wt %, and 24 wt %, respectively, in toluene (for Examples 70, 71, and 72, respectively). High shear mixers were used to prepare the solutions on an industrial scale. The same PMMA film used in previous Examples was used at the top layer material, and was supplied in the form of 12 inch (30.5 centimeters) wide stock rolls. A conventional gravure coater was employed. The coater was equipped with automatic web handling, speed control electronics, and a high-flow air circulation oven capable of drying the coatings online. The line was run at speeds such that the residence time in the oven was approximately 2 to 3 minutes. The oven was set at temperatures of 70° to 80° C. The dry coating thickness was determined by the choice of gravure roll and the concentration of polymer solids in the coating solution. A gravure roll was chosen such that the three prepared solutions would yield dry coatings of approximately ⅓ micrometer, 1 micrometer, and 2 micrometers (Examples 70, 71, and 72, respectively).

Transmission measurements were performed on all three coated films to determine if the coating had increased haze. The Example 70 film having the ⅓ micrometer coating thickness exhibited some evidence of interference pattern at near UV-VIS wavelengths. The Examples 71 and 72 films made at 1 and 2 micrometer base layer thicknesses, respectively, exhibited no haze or interference as compared with unmodified PMMA.

A 14 inch (35.6 centimeter) three-chamber roll-to-roll vapor coater was used to deposit TiO₂, silver and copper layers on the rolls of PMMA coated with block copolymer. A roll was loaded on an unwind/rewind station in the first chamber of the apparatus, threaded through the apparatus and onto the unwind/rewind station in the third chamber, and the entire apparatus was sealed. The coating chamber was evacuated, using a mechanical pump stack, to below 1 millitorr, and then gate valves leading to a cryogenic pump were opened, to achieve a vacuum level of about one millionth of a ton. The first chamber had a planar DC-magnetron sputtering source (Advance Energy Industries, Inc., Fort Collins, Colo.). The second chamber was equipped with two electron beam guns, each having four pockets to enable evaporative deposition of up to four different materials using back-and-forth web passes.

The web was conveyed at about 5 ft/min (1.5 m/min) to deposit TiO₂ in the reactive sputtering environment of the first chamber. Oxygen and argon were introduced to elevate pressure to 1 millitorr, providing for full oxidation of the titanium metal on the cathode into TiO₂. In the same pass, the e-beam shutters were opened to expose the TiO₂-coated film to silver vapor from silver wire pieces in one of the e-beam pockets in the second chamber. The rate of silver deposition and thickness was monitored using a DELCOM brand online conductivity measurement device (Delcom Instruments, Inc., Prescott, Wis.). A value of 5 mho had previously been determined to correlate with a sufficient thickness of silver to adequately reflect the solar spectrum. The TiO₂ thickness was determined by using the power, pressure and web speed as inputs to an equation derived from earlier calibration runs for which the thickness had been measured using TEM and Interference measurement. As the silver was being deposited, the web was cooled by being in contact with a water chilled (about 5° C.) drum, minimizing the thermal load from the e-beam and sputtering depositions.

After the entire roll had been processed, the TiO₂ sputtering was turned off and the e-beam shutter was closed. A fresh pocket filled with copper wire pieces was moved into place. When predetermined power settings were reached, the e-beam shutters were opened, and the web was moved from the third chamber back to the first chamber to deposit copper on top of the silver, in the second chamber. The conductance monitor was used to determine the thickness of the copper. A value of 2 mho had previously been determined to correlate with a 20 nm thickness of copper. Thus, the speed of the web on this second pass was adjusted to achieve an additional 2 mhos of conductivity beyond the 5 mhos achieved during the deposition of the silver layer. After copper deposition, the e-beam pockets were allowed to cool for several minutes. Then the coater was backfilled with dry nitrogen. Finally, the apparatus was opened and the vapor-coated roll was removed from the unwind/rewind station.

Reflection measurements were performed on all three coated films. The Examples 71 and 72 films made with base layers of 1 and 2 micrometer thicknesses exhibit excellent reflectivity throughout the visible wavelength range. The Example 70 film made with a base layer of ⅓ micrometer thickness matched the reflectivity of the other two films at higher wavelengths, but exhibited lesser reflectivity at lower wavelength, with reflectivity falling from about 97% at about 1100 nm to about 90% at about 550 nm.

For Example 73, PMMA-based control specimens were prepared in exactly the same way, except the PMMA top layer film was not coated with a block copolymer base layer prior to metallic layer deposition.

Wet peel strength was measured, as described in previous Examples, on multiple specimens of all four of these film types. The Example 73 PMMA-based control specimens, lacking a block copolymer base layer, exhibited wet peel forces of about 0.4-0.5 lbf. All three of the Example 70-72 films, having block copolymer base layers, exhibited wet peel forces of about 1.4-1.5 lbf. Further, the failure patterns were markedly different. For the Example 73 PMMA-based control specimens, the metallic layer peeled off the PMMA completely, while the Example 70-72 films, having the block copolymer base layer, failed at the interface between the adhesive and the aluminum plate in the peel test.

These four films were then subjected to outdoor exposure in a manner identical to that described in previous Examples. Some specimens of each film were tested for wet peel adhesion after 7 days of outdoor exposure. Some specimens of each film were tested for wet peel adhesion after 28 days of outdoor exposure. Again, all Example 73 PMMA-based specimens, lacking a block copolymer base layer, failed at the interface between the metallic layer and the PMMA, while all the Example 70-72 specimens, having a block copolymer base layer, failed at the interface between the PSA layer and the copper layer in the testing. Results are summarized in Table 5.

TABLE 5
Continuous Process (Roll-to-Roll) Films

| | | | | | Wet Peel | Wet Peel |
|---|---|---|---|---|---|---|
| | Coating | | | | After 7 Days | After 28 days |
| | Solution | Base Layer | | Reflectivity | Outdoor | Outdoor |
| | Concentration | Thickness | | After | Exposure | Exposure |
| Example | Weight % | micrometers | Transparency | Metallizing | lbf (avg) | lbf (avg) |
| 70 | 4% | 0.33 | Slight haze | Less at low | 2.0 | 1.8 |
| | | | | wavelengths | | |
| 71 | 12% | 1.0 | Excellent | Excellent | 1.7 | 1.5 |
| 72 | 24% | 2.0 | Excellent | Excellent | 1.5 | 1.4 |
| 73 | none | none | Excellent | Excellent | 0.4 | 0.4 |

### Examples 74-76

### Long-Term Corrosion Resistance in Deionized Water

An experiment was performed to determine the resistance of certain constructions to long term wet environments. Example 74 is similar to Example 71, except that the film was laminated with the acrylic PSA to a 12 inch by 12 inch (30.5 centimeter) aluminum panel. Example 75 is similar to Example 74, except that the thickness of the TiO₂ layer was 40 nm thick, rather than 5 nm. Example 76 is similar to Example 74, except that the oxide layer was ZrO₂, instead of TiO₂. These Examples were submerged in deionized water within a 1000 liter vessel at room temperature. The data suggests that TiO₂ provides better corrosion resistance than, e.g., ZrO₂. However, a thicker oxide layer did not necessarily provide higher corrosion resistance. Results are summarized in Table 6.

TABLE 6
Corrosion resistance to deionized water immersion (days)

| Example | | 8 days | 15 days | 21 days | 29 days | 41 days | 73 days |
|---|---|---|---|---|---|---|---|
| 74 | 5 nm | Excellent | Excellent | Excellent | Excellent | Excellent | Excellent |
| | TiO₂ | | | | | | |
| 75 | 40 nm | Excellent | Excellent | Very minor | Very minor | Very minor | Very minor |
| | TiO₂ | | | erosion | erosion | erosion | erosion |
| | | | | along 50% | along 80% | along 100% | along 100% |
| | | | | perimeter | perimeter | perimeter | perimeter |
| 76 | 5 nm | Excellent | Excellent | Very minor | Very minor | Very minor | Very minor |
| | ZrO₂ | | | erosion | erosion | erosion | erosion |
| | | | | along 50% | along 80% | along 90% | along 100% |
| | | | | perimeter | perimeter | perimeter | perimeter |

### Examples 77-82

### Salt Spray Testing at Various Base Layer Thicknesses

An experiment was performed to determine the resistance of certain constructions to salt spray. Examples 77-82 are similar to Example 71, except that the thickness of the base layer was varied to see if that had an effect on corrosion resistance. These Examples were subjected to a salt spray test for 550 hours in a 1000 liter salt spray chamber. The chamber settings for temperature and the pH, and NaCl concentration of the condensing fog adhered to ASTM B 117. Results are summarized in Table 7.

TABLE 7
Salt spray testing of samples having a base layer of varying thickness

| | | | Area of the sample |
|---|---|---|---|
| | Number of | Thickness of | blank corroded after |
| | samples of | the base layer | 550 hours in the salt spray |
| | the Example | of LA4285 | (mean of the samples) |
| Example | tested | (micrometers) | (% of the surface) |
| 77 | 2 | 0.27 | 10 |
| 78 | 2 | 0.40 | 23 |
| 79 | 2 | 0.67 | 12 |
| 80 | 4 | 1.00 | 36 |
| 81 | 2 | 2.00 | 68 |
| 82 | 2 | 3.00 | 25 |

All of the patents and patent applications mentioned above are hereby expressly incorporated into the present disclosure. The foregoing invention has been described in some detail by way of illustration and example for purposes of clarity and understanding. However, various alternatives, modifications, and equivalents may be used and the above description should not be taken as limiting in the scope of the invention which is defined by the following claims and their equivalents.

1. A reflective article comprising:
a base layer having a first and second surface, the base layer being non-tacky at ambient temperatures and comprising a block copolymer with at least two endblock polymeric units that are each derived from a first monoethylenically unsaturated monomer comprising a methacrylate, acrylate, styrene, or combination thereof, wherein each endblock has a glass transition temperature of at least 50 degrees Celsius; and at least one midblock polymeric unit that is derived from a second monoethylenically unsaturated monomer comprising a methacrylate, acrylate, vinyl ester, or combination thereof, wherein each midblock has a glass transition temperature no greater than 20 degrees Celsius; and
a metallic layer extending across at least a portion of the second surface.

2-6. (canceled)

7. The article of claim 1, further comprising a tie layer located between the base layer and the metallic layer, the tie layer comprising a metal oxide.

8. The article of claim 2, wherein the metal oxide is titanium dioxide.

9-10. (canceled)

11. The article of claim 1, wherein the metallic layer comprises one or more metals selected from the group consisting of: silver, gold, aluminum, copper, nickel, and titanium.

12. The article of claim 4, wherein the metallic layer comprises a silver layer adjacent the base layer and a copper layer remote from the base layer.

13. (canceled)

14. The article of claim 1, wherein the base layer further comprises a nanofiller dispersed in the block copolymer, wherein the nanofiller is selected from the group consisting of silicon dioxide, zinc oxide, titanium dioxide, aluminum oxide and zirconium oxide.

15. (canceled)

16. The article of claim 1, wherein the block copolymer contains an amount ranging from 0.5 to 3.0 percent of an ultraviolet light absorber, based on the total weight of the block copolymer and absorber.

17. The article of claim 1, further comprising a top layer in contact with the first surface, the top layer comprising poly(methyl methacrylate).

18. (canceled)

19. The article of claim 8, wherein the top layer further contains an amount ranging from 0.5 to 3.0 percent of an ultraviolet light absorber, based on the total weight of the poly(methyl methacrylate) and absorber.

20. The article of claim 1, wherein each endblock comprises poly(methyl methacrylate) and each midblock comprises poly(butyl acrylate).

21. (canceled)

22. The article of claim 10, wherein the block copolymer comprises 50 to 70 percent endblocks and 30 to 50 percent midblocks based on the total weight of the block copolymer.

23. The article of claim 10, wherein the base layer comprises a blend of the block copolymer and a poly(methyl methacrylate) homopolymer.

24. (canceled)

25. The article of claim 12, wherein the blend has an overall poly(methyl methacrylate) composition ranging from 50 to 80 percent based on the total weight of the blend.

26. The article of claim 10, wherein the base layer comprises a blend of the block copolymer with at least one compositionally different block copolymer having endblocks comprising poly(methyl methacrylate) and a midblock comprising poly(butyl acrylate).

27. (canceled)

28. A reflective article comprising:
a base layer having a first and second surface, the base layer comprising a random copolymer with at least a first polymeric unit and second polymeric unit, the first polymeric unit derived from a first monoethylenically unsaturated monomer comprising a methacrylate, acrylate, styrene, or combination thereof and associated with a glass transition temperature of at least 50 degrees Celsius and the second polymeric unit derived from a second monoethylenically unsaturated monomer comprising a methacrylate, acrylate, vinyl ester, or combination thereof and associated with a glass transition temperature no greater than 20 degrees Celsius;
a top layer extending across at least a portion of the first surface comprising poly(methyl methacrylate); and
a metallic layer extending across at least a portion of the second surface.

29. The article of claim 15, wherein the first polymeric unit comprises methyl methacrylate and the second polymeric unit comprises butyl acrylate.

30. (canceled)

31. The article of claim 16, wherein the random copolymer comprises 70 to 80 percent methyl methacrylate based on a total weight of the random copolymer.

32. The article of claim 16, further comprising a tie layer located between the base layer and the metallic layer, the tie layer comprising a metal oxide.

33. A method of making a reflective article, comprising:
providing a base layer having a first and second surface, the base layer being non-tacky at ambient temperatures and comprising a block copolymer with at least two endblock polymeric units that are each derived from a first monoethylenically unsaturated monomer comprising a methacrylate, acrylate, styrene, or combination thereof, wherein each endblock has a glass transition temperature of at least 50 degrees Celsius; and at least one midblock polymeric unit that is derived from a second monoethylenically unsaturated monomer comprising a methacrylate, acrylate, vinyl ester, or combination thereof, wherein each midblock has a glass transition temperature no greater than 20 degrees Celsius; and
applying a metallic layer along the second surface to provide a reflective surface.

34-35. (canceled)

36. The method of claim 19, further comprising applying a top layer comprising poly(methyl methacrylate) to the first surface.

37-38. (canceled)
